(19) United States
(12) Patent Application Publication
(10) Pub. No.: US 2007/0162839 A1
(43) Pub. Date: Jul. 12, 2007

(54) Syndicated audio authoring

(76) Inventors: John Danty, Cupertino, CA (US); Matt Evans, San Francisco, CA (US); Kerstin Heitmann, Hamburg (DE); Jan-Hinnerk Helms, Hamburg (DE); Ole Lagemann, Hamburg (DE); Thorsten Quandt, Hamburg (DE); Alexander Soren, San Francisco, CA (US); Jeffrey Wesley Taylor, San Francisco, CA (US)

Correspondence Address: HICKMAN PALERMO TROUNG & BECKER LLP;AND APPLE INC., 2055 GATEWAY PLACE, SUITE 550, SAN JOSE, CA, 95110-1089, US

(21) Appl. No.: 11/329,353

(22) Filed: Jan. 9, 2006

(51) Int. Cl. G06F 17/00

(52) U.S. Cl. 715/500.1

(57) ABSTRACT

A technique for authoring multimedia presentations is provided such that a user may specify visual data to be displayed during the entirety of the playback of the presentation except for portions that have been defined to display alternate visual data. The authoring workflow utilizes a timeline within which may be placed marker regions with several independently editable parameters.

### FIELD OF THE INVENTION

The present invention relates to media broadcasts, and more specifically to a technique for authoring media broadcasts.

### BACKGROUND

With the advent of digital media, various techniques have been devised to create multimedia presentations that combine audio and visual elements. For example, an audio presentation may be combined with a digital image, such that the image is displayed while the audio portion is played. Different images may be displayed at different points of the presentation.

Techniques for creating multimedia presentations exist whereby an audio presentation is defined by a timeline along which the presentation proceeds, and static images may be placed at points along the timeline corresponding to a time in the presentation. For example, an audio presentation may be defined as having a playback time of twenty seconds, with a particular image to be displayed for two seconds when the presentation reaches the five second mark and another image displayed for ten seconds when the presentation reaches the nine second mark.

Prior approaches attempt to simplify the creation of presentations as described above by allowing for the graphical placement of elements along a timeline. These approaches suffer from drawbacks such as requiring a user to manually place an image at several different points along the timeline of a presentation, if the user desires that image to be displayed at all points in the presentation where other images are not selected to appear.

Further, prior approaches to simplify the creation of multimedia presentations only allow the placement of containers on a timeline, the containers being used to display an image for a user-defined duration as described above. Because the containers in the prior approaches are only used to hold images for display at a certain point in a timeline, it would be advantageous to provide an approach that allowed for enhanced information to be associated with the containers in addition to a static image.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a mechanism for authoring enhanced multimedia presentations, according to an embodiment of the invention;

FIG. 2 illustrates an example of utilizing a mechanism for authoring enhanced multimedia presentations, according to an embodiment of the invention; and

FIG. 3 is a block diagram of a computer system on which embodiments of the invention may be implemented.

### OVERVIEW

Techniques are described herein for authoring multimedia presentations, comprising audio and/or visual elements, which may be placed on the Internet for downloading and later viewing. These multimedia presentations are also known as “podcasts.” The term “podcast” is a combination of two words: “iPod” and “broadcasting.” The term is a misnomer since neither podcasting nor listening to podcasts requires an iPod or any portable player, and no broadcasting is required. A common form of a podcast is that of an audio file, although digital images may be associated with the audio file, such that the images are displayed during the podcast.

According to an embodiment, a podcast is an audio track authored on a timeline. The audio track of a podcast is represented by a timeline extending for the duration of the audio. Visual data that may appear in the podcast exist on a so-called Podcast track, also authored on a timeline. Portions of the timeline, and therefore the Podcast track that makes the visual part of the podcast, may be populated with visual data and/or one or more “marker regions.” For example, visual data such as a digital image may be associated with the entire podcast track, such that the image is displayed at all times that another portion of visual data is not defined to appear. This is the “Episode Artwork,” or “default visual data” for a podcast. This default visual data may exist in addition to one or more marker regions, which are user-defined portions in the authoring environment that are placed on the podcast timeline and serve to logically divide the podcast.

For purposes of this application, the audio track and Podcast track may be considered interchangeable, such that visual data said to be “associated with” an audio track or selection may be “associated with” the Podcast track and vice versa. “Associated with” in this sense may be meant in a logically associative fashion as well as physically. According to an embodiment, there is no connection between the audio track and the digital images, such that embodiments exist without even having an audio track or an audio selection, in which case the images are associated with a “Podcast track” or equivalent item.

According to an embodiment, each marker region may contain several properties, such as whether visual data will be displayed during the portion of the podcast encompassing the marker region and what, if any, visual data is to be associated with the marker region during playback. According to an embodiment, each marker region may contain several properties, such as whether visual data will be displayed during the portion of the podcast encompassing the marker region and what, if any, visual data is to be associated with the marker region during playback. To allow for enhanced information to be associated with the marker regions in addition to static images, further properties may be added to each marker region. These further properties may be whether this marker region is a chapter (and if yes, which name the chapter should have), and whether this marker region allows the connection to a user-specified URL (and if yes, which URL it should be, and with which name this URL should appear in the marker region).

According to an embodiment of the invention, a technique is provided for authoring a podcast such that playing the authored podcast causes the default visual data to be displayed while the audio of the podcast is being played. Specifying default visual data, in combination with the use of marker regions, defines what, if any, visual data is displayed at any one point during the podcast.

According to an embodiment of the invention, the default visual data is displayed until a portion of the podcast containing a marker region, authored with a property specifying the display of visual data associated with the marker region, is played. When a portion of the podcast containing a marker region so authored is played, the visual data associated with the marker region is displayed in place of the default visual data for the duration of the marker region. Once the marker region is no longer being played, the default visual data is automatically redisplayed.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

For illustrative purposes, embodiments of the invention are described in connection with a mechanism for creating audio presentations with associated images. Various specific details are set forth herein and in the Figures, to aid in understanding embodiments of the present invention. However, such specific details are intended to be illustrative, and are not intended to restrict in any way the scope of embodiments of the present invention as claimed herein. In addition, the particular screen layouts, appearance, and terminology as depicted and described herein are intended to be illustrative and exemplary and in no way limit the scope of embodiments of the present invention as claimed herein.

In one embodiment, an embodiment of the present invention is implemented in a conventional personal computer system, such as an iMac, Power Mac, or PowerBook (available from Apple Computer, Inc. of Cupertino, Calif.), running an operating system such as Mac OS X (also available from Apple Computer, Inc.). It will be recognized that other embodiments of the invention can be implemented on other devices as well, such as handhelds, personal digital assistants (PDAs), mobile telephones, consumer electronics devices, and the like. One embodiment of the present invention is the GarageBand software package (available from Apple Computer, Inc. of Cupertino, Calif.), running on an operating system such as Mac OS X (also available from Apple Computer, Inc.). Other embodiments of the invention exist that are compatible with other software that runs on the personal computer, that can be included as add-on software, can form part of the operating system itself, or that can be a feature of an application that is bundled with the computer system or sold separately.

The various features of various embodiments of the invention as described herein include output presented on a display screen that is connected to the personal computer. In addition, various embodiments of the invention make use of input provided to the computer system via input devices such as a keyboard, mouse, touchpad, or the like. Several Figures are presented as screen shots depicting examples of the user interface as it might appear on a display screen or other output device.

### Presentation Authoring

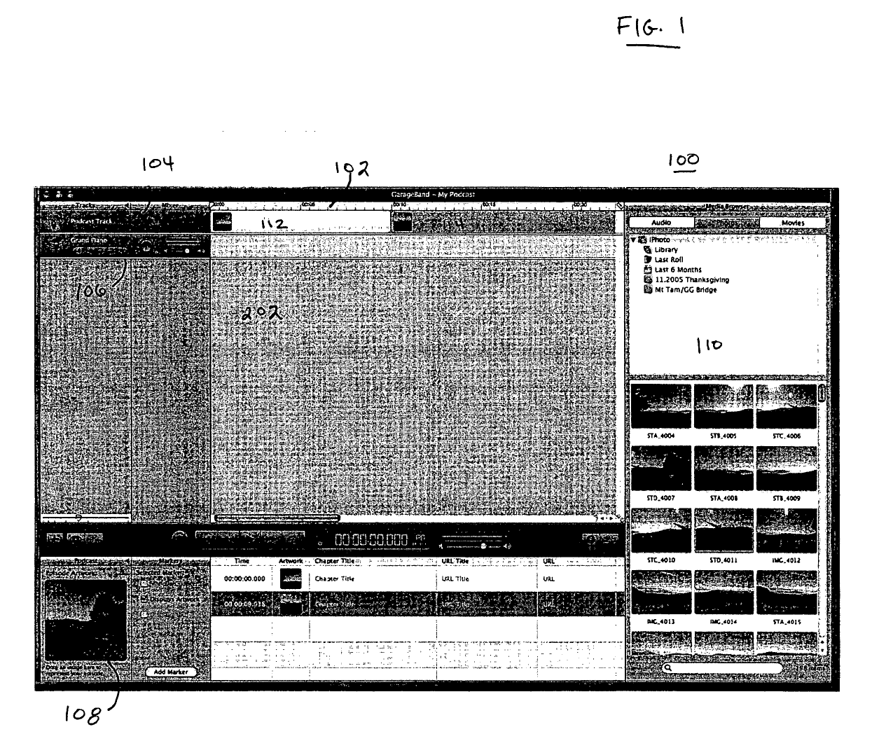

FIG. 1 illustrates a mechanism for authoring enhanced multimedia presentations, according to an embodiment of the invention, as implemented in the GarageBand software package, as described earlier. However, it should be understood that the techniques described herein may be embodied in other software that runs on the personal computer.

In FIG. 1, the podcast authoring system 100 displays a timeline 102 upon which may be placed any number of “tracks”. The tracks are visually represented for ease of use and manipulation 104, 106. These tracks visually represent any number of audio sources, such as a voice track or a piano track. The tracks may also visually represent digital image sources. The entirety of the tracks 104, 106 comprise the podcast.

### The Default Visual Data

According to an embodiment, the podcast authoring system may be used to associate a default visual data with the entire podcast. This default visual data, or “episode artwork,” will be displayed during playback of the podcast on a device capable of displaying images. According to an embodiment, the default visual data to be used for a podcast may be manually selected using controls provided by the podcast authoring system 100. For example, an image or other graphical representation of a file may be dragged to a location in the authoring environment 108 signifying that the image and/or file is to be used as the default visual data. The ability to associate visual data with the entire podcast, which will be displayed at all points in the presentation where other visual images associated to Marker Regions are not selected to appear, gives the user the advantage that he no longer has to manually place an image at several different points along the timeline of a presentation, if the user desires that image to be displayed at all points in the presentation where other images are not selected to appear.

According to an embodiment, images available for use in authoring the podcast may be collected in a library 110 and be available for easy browsing and dragging to the episode artwork location 108. According to an embodiment, this library is populated through intra-application communication with an image handling application such as iPhoto, from Apple Computer as described above, although the technique can be embodied in other software that runs on the personal computer.

### Marker Regions—Displays Artwork

While a podcast may be comprised of audio tracks and a default visual data, one embodiment envisions the use of “marker regions” 112, 114. These regions 112, 114 are visual representations of discrete portions of the podcast. According to an embodiment, a marker region may have several properties associated with it. For example, a marker region may have a property known as “Displays Artwork,” or similar moniker. This property indicates that during playback of the portion of the podcast identified by the marker region, a particular visual content associated with the marker region will be displayed on the playback device (assuming the playback device is capable of displaying images). The visual content that is associated with a marker region may be the same as the visual content that is used for the default visual data, but in the preferred embodiment the visual content is different.

Using this property, a marker region serves as a “container” for the visual content associated with the container. According to an embodiment, the visual content may be one or several different images or a video file or video stream.

### Marker Regions—New Chapter

According to an embodiment, another property of marker regions is whether the marker regions signifies the beginning of a new chapter. Podcasts may be comprised of chapters, which are discrete logical dividers often used to delineate portions of the podcast by playback devices. An example is the use of chapter in DVD systems. By advancing to the next chapter of a DVD, or podcast, the user advances ahead in the DVD, or podcast, to the next logical chapter divider. This is more efficient than fast-forwarding to a future portion of the presentation or rewinding to a past portion. When the chapter property of a marker region is turned off, the marker region is ignored when the user is jumps from chapter to chapter. Consequently, a user may insert into the timeline any number of marker regions not signifying a chapter divider, yet allow the user to skip over all of them and to the next marker region with the chapter property on. The ability to turn off the “chapter property” of a marker region means that the user does not have to skip to each and every marker region in turn, which could become tedious. A visual indicator may be used indicating that this point in the timeline is the start of a marker region which has the chapter property turned on.

### Chapter Titles

According to an embodiment, each chapter may have a title associated with it, such that the chapter title may be displayed during playback of the podcast. According to an embodiment, the chapter titles may be authored to appear during playback, such that they may be used to navigate using a chapter-selection menu where the chapters are listed by their respective titles as defined in the authoring environment.

### Displays URL Property

According to an embodiment, another property of marker regions is the “Displays URL” property. The Displays URL property indicates whether a Uniform Resource Locator (“URL”) will be displayed during a portion of the podcast. This URL may be superimposed over any artwork currently displayed. According to an embodiment, this URL is user definable by the user of the authoring system.

During playback of a podcast, when the portion of the podcast identified by a marker region with this property is played, a URL associated with the marker region is displayed (if the playback device is capable of displaying images). According to an embodiment, the URL may be “clickable,” or capable of receiving user input on the URL text in the display such that a browser or similar application is launched that in turn navigates to the URL on the Internet.

According to an embodiment, the URL may have a title associated with it. In one embodiment, this title is displayed in lieu of the actual URL. For example, instead of the URL “http://www.apple.com” being displayed during the playback of the portion of the podcast comprising a marker region with this property, a title associated with the URL, such as “Apple,” may instead be displayed. This eliminates user confusion, is more readable, and can take up significantly less screen space than a long URL. According to an embodiment, the URL title may be “clickable.” According to an embodiment, the clickable URL Title may be superimposed over the artwork along with a visual indicator establishing that the text is clickable, such as the text being underlined. Any numbers of visual effects are contemplated.

According to an embodiment, numerous additional properties are contemplated as being associable with marker regions. Each marker region's properties can be edited independently from each other and selectively switched on and off.

### Presentation Authoring Interface and Techniques

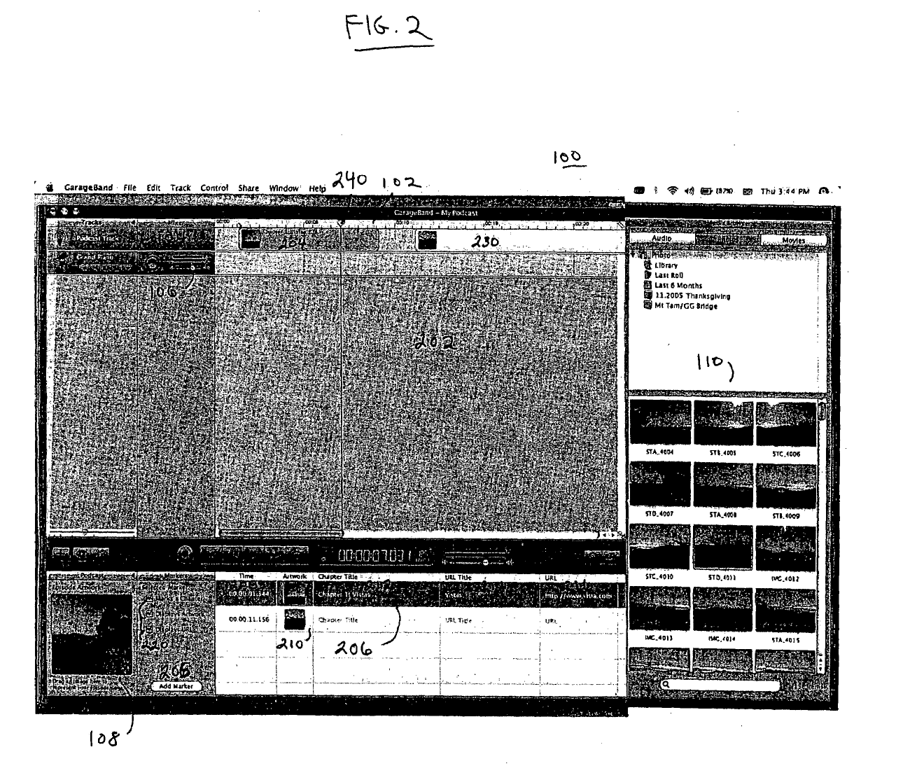

FIG. 2 illustrates an example of utilizing an embodiment of the invention as embodied in the GarageBand software package, as described earlier. However, while reference may be made to the example shown in FIG. 2, it should be understood that the techniques described herein may be embodied in other software that runs on the personal computer.

In FIG. 2, a user may define the default visual data by dragging an image or other file from the library 110 to the “Episode Artwork” well 108. A user may select an image from a dialog box or use another method of selecting a file offered by the operating system upon which the software embodying the disclosed techniques is executing. This default visual data serves as a default image to be displayed during playback of the podcast. If no other marker regions with the “Display Artwork” property are defined in the podcast, the default visual data will be the only image displayed. In the example illustrated in FIG. 2, a user has defined the “Episode Artwork,” 108 or default visual data to be an image.

According to one embodiment, an image is dragged from the library 110 to a work area 202 to create a marker region 204. According to other embodiments, a marker region may be created using a GUI element such as a button 205. Once a marker region 204 is created and placed on the timeline 102, properties of the marker region 204 are displayed 206. In one embodiment, these properties may consist of the time the marker region 204 originates 208 on the timeline, a representative sample of the artwork that will be displayed 210 by the marker region 204, the chapter title 212 used by the marker region 204 if it signifies a chapter indicator, the title 214 of the URL associated with the marker region 204, and the actual URL 216 associated with the marker region 204. Several other properties are envisioned in other embodiments of the invention, such as duration of the marker region.

According to an embodiment, a user may specify the beginning time 208 of a marker region by typing the time as user input or dragging the graphical representation of the marker region 204 along the timeline 102 to the time at which the marker region should begin. As a user drags the marker region 204, the actual beginning time in the property view 208 is updated. According to an embodiment, the beginning and/or end of, or the duration of a marker region, may be changed by user input such as typing, or simply stretching or dragging an end of the marker region 204 along the timeline 102, much as a drawing may be stretched in an image creation application.

According to an embodiment, multiple marker regions may be moved along the timeline at once. The marker regions may be contiguous or noncontiguous. According to an embodiment, one marker region may be placed within another marker region. According to en embodiment, if a marker region is placed overlapping the end of an existing marker region, then the existing marker region will be truncated to eliminate the overlap. According to an embodiment, if a marker region is placed wholly within an existing marker region, then the existing marker region will be divided, with one side on each side of the newly-placed marker region. By this method, overlapping marker regions may be automatically avoided, although other embodiments are envisioned wherein marker regions may overlap.

If an image or other visual content is associated with the marker region 204, a representative sample 210 of the image or other visual content may be displayed. According to an embodiment, the display of an image or other visual content may be toggled on or off through a preference. According to various embodiments, other properties of a marker region 204 may be toggled on or off, such as whether the marker region 204 marks a chapter, as described above, and whether a URL associated with the marker region 204 is displayed. These toggles also may be represented through the use of GUI elements such as a checkbox 220. According to an embodiment, these properties may be individually set for each separate marker region 204.

If the marker region 204 is to serve as a chapter, as described above, then a user may enter a title 212 for the chapter that may be displayed during playback of the chapter, according to an embodiment. If a marker region does not serve as a chapter, then there is no need to enter a title. If the marker region 204 is associated with a URL, then the URL may be entered by a user 216. If a title is associated with the URL, that may be entered by a user 214.

In the example illustrated in FIG. 2, a user has created two marker regions 204, 230 in the podcast. The first region 204 begins at time 00:00:01.344 and is selected for editing in the marker regions properties section 206. This selection is indicated by a reverse highlight, although other methods of indication are envisioned. The selected marker region 204 marks a chapter, displays artwork, and displays a URL, as seen by the marker preference checkboxes 220. Because the marker region marks a chapter, a chapter title of “Chapter 1: Vistas” is entered 212. Because the marker region displays a URL, a URL of “http://www.vista.com” is entered 216. To make the URL easier to read and click, a URL title of “Vistas” 214 is entered.

According to an embodiment, a marker 240 is used to indicate the current position within the podcast. The entire environment 100 serves to define a podcast. The podcast as currently defined in FIG. 2 would proceed as follows. At time 00:00:00, the podcast begins. The Episode Artwork, or default image, would be displayed. At time 00:00:01.344, the image associated with the marker region 204 would be displayed, along with the URL title and, in one embodiment, the chapter title. After the marker region 204 ends at approximately 00:00:09:00, the default image will be redisplayed and all elements of the previously-displayed marker region 204 will disappear. At approximately time 00:00:11.156, a second marker region 230 begins, and the image associated with the marker region is displayed in place of the Episode Artwork. Because no Chapter Title or URL is associated with the second marker region 230, the image is the only item on the display, according to an embodiment.

### Hardware Overview

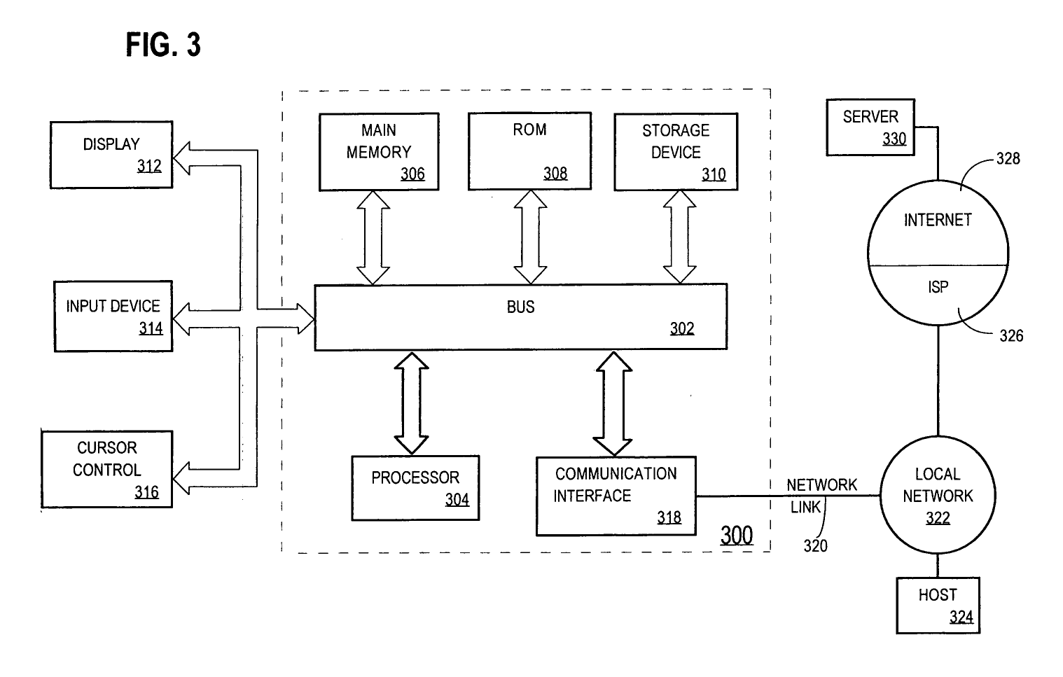

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 33. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 33. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 33 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

### Extensions and Alternatives

Alternative embodiments of the invention are described throughout the foregoing description, and in locations that best facilitate understanding the context of the embodiments. Furthermore, the invention has been described with reference to specific embodiments thereof. It will, however, be evident that various modifications and changes may be made thereto without departing from the broader spirit and scope of the invention. Therefore, the specification and drawings are, accordingly, to be regarded in an illustrative rather than a restrictive sense.

In addition, in this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

Further, in the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
receiving input that associates a digital image with an audio selection;
receiving input that defines a first set of one or more marker regions;
wherein each marker region in the first set of marker regions is associated with an alternate digital image;
wherein each marker region in the first set of marker regions is associated with a portion of the audio selection; and
during playback of said audio selection, performing the steps of
causing the alternate digital image associated with a marker region to be displayed during playback of the portion of the audio selection that is associated with the marker region; and
causing the digital image to be displayed during portions of the audio selection where no alternate digital image is displayed.

2. The method of claim 1, wherein the instructions include instructions for defining marker regions for the audio selection, and setting properties of the marker regions that are defined for the audio selection, in response to input.

3. The method of claim 1, further comprising instructions which, when executed by one or more processors, cause the one or more processors to perform the steps of:
displaying a visual representation of the audio selection along a timeline;
displaying visual elements corresponding to the marker regions;
placing the visual elements on the timeline in response to user input;
receiving user input altering at least one of the size or position, along the timeline, of one or more of the visual elements corresponding to the marker regions;
in response to user input, changing properties of the visual elements.

4. The method of claim 1, wherein multiple visual elements corresponding to the marker regions may be manipulated at the same time in response to the same user input.

5. The method of claim 1, further comprising:
in response to receiving user input placing at least a portion of a first visual element, corresponding to a marker region, within or overlapping the boundaries of a second visual element corresponding to a second marker region, causing properties of the second marker region to be altered without altering the duration of the first marker region.

6. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
receiving input that defines a first set of one or more marker regions having one or more properties;
causing to be selected, on a property-by-property basis, which properties of a marker region are activated during playback of the portion of the audio selection associated with the marker region;
associating the marker regions with the audio selection.

7. The method of claim 6, wherein the instructions include instructions for selecting, on a property-by-property basis, which properties of a marker region are activated during playback of the portion of the audio selection associated with the marker region.

8. The method of claim 7, wherein one of the properties is a property that indicates whether the marker region represents a start of a chapter.

9. The method of claim 8, wherein one of the properties comprises a chapter title

10. The method of claim 6, wherein one of the properties is a property that indicates whether an alternative image has been specified for the marker region.

11. The method of claim 6, wherein one of the properties is a property that indicates whether a designated URL is to be displayed during playback of the portion of the audio selection that corresponds to the marker region.

12. The method of claim 6, wherein the instructions include instructions for causing a resource associated with a URL to be retrieved in response to selection of the URL while the URL is displayed during playback of the portion of the audio selection that corresponds to the marker region associated with the URL

13. The method of claim 6, wherein one of the properties is a property that indicates whether a designated URL is to be represented by alternate data.

14. The method of claim 6, wherein the instructions include instructions for:
receiving input manipulating a representation of a particular marker region; and
causing properties of the particular marker region to be changed in response to the input.

15. The method of claim 6, wherein the instructions include instructions for:
receiving input manipulating a set of two or more representations of a particular marker region; and
causing properties of the particular set of marker regions to be changed in response to the input.

16. The method of claim 6, wherein the properties comprise the time at which the marker region is to begin and end.

17. The method of claim 6, wherein the one of the properties is a property that indicates the duration of the marker region.

18. The method of claim 6, wherein a graphical display of the properties to be altered in response to the input.

19. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
associating a first digital image with a media file;
displaying a timeline that represents the duration of the media file;
associating a marker region with a second digital image;
receiving input that associates the marker region with a portion of the timeline; and
causing the first digital image to be displayed during playback of portions of the media file not associated with the portion of the timeline associated with the marker region.

20. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
displaying a timeline that represents the duration of a media file;
associating a marker region with a portion of the timeline;
receiving input that specifies which properties, of a plurality of available properties, are turned on for the marker region;
during playback of the portion of the media file that corresponds to the portion of the timeline, performing one or more operations based on which properties were turned on for the marker region.
